(19) United States
(12) Patent Application Publication
(10) Pub. No.: US 2014/0281590 A1
(43) Pub. Date: Sep. 18, 2014

(54) BATTERY POWER MANAGEMENT FOR ELECTRONIC DEVICE

(71) Applicants: IOAN SAUCIUC, Phoenix, AZ (US); LOUIE Y. LIU, VANCOUVER, WA (US); ROBERT F. KWASNICK, Palo Alto, CA (US); SURINDER K. TULI, Chandler, AZ (US)

(72) Inventors: IOAN SAUCIUC, Phoenix, AZ (US); LOUIE Y. LIU, VANCOUVER, WA (US); ROBERT F. KWASNICK, Palo Alto, CA (US); SURINDER K. TULI, Chandler, AZ (US)

(21) Appl. No.: 13/836,291

(22) Filed: Mar. 15, 2013

(51) Int. Cl. G06F 1/30; G06F 11/30

(52) U.S. Cl. CPC G06F 1/30; G06F 11/3058
USPC 713/300

(57) ABSTRACT

In one embodiment a controller comprises logic to receive a temperature indicator for an electronic device to be coupled to a first battery and implement a selected power management routine when a temperature parameter derived from the temperature indicator is below a threshold. Other embodiments may be described.

### RELATED APPLICATIONS

None.

### BACKGROUND

The subject matter described herein relates generally to the field of electronic devices and more particularly to a battery power management for electronic devices.

Electronic devices such as, e.g., laptop computers, notebook computers, tablet computers, mobile phones, electronic readers, and the like have one or more batteries that power the device. The electronics industry has migrated toward Lithium-based batteries, and particularly toward Lithium-ion batteries, in recent years. Many batteries, including Lithium-ion batteries exhibit decreased discharge performance at low temperatures. This decrease in battery discharge performance at low temperatures can affect performance of an electronic device, particularly during a boot-up stage. Accordingly systems and methods for battery power management may find utility.

### BRIEF DESCRIPTION OF THE DRAWINGS

The detailed description is described with reference to the accompanying figures.

FIGS. 1 and 2 are high-level schematic illustrations of an electronic device which may be adapted to include battery power management in accordance with some embodiments.

FIG. 3 is a flowchart illustrating operations in a method for battery power management in accordance with some embodiments.

FIGS. 4 and 5 are schematic illustrations of techniques for battery power management in an electronic device in accordance with some embodiments.

FIGS. 6-9 are schematic illustrations of electronic devices which may be modified to implement battery power management in accordance with some embodiments.

### DETAILED DESCRIPTION

Described herein are exemplary systems and methods to implement battery power management in electronic devices. In some embodiments described herein an electronic device may comprise one or more temperature sensors which senses a temperature proximate a battery to be coupled to the electronic device. The electronic device further includes a power driver which receives a temperature indication from the one or more temperature sensors. The power driver derives a temperature parameter from the temperature indicator and implements a selected power management routine when a temperature parameter derived from the temperature indicator is below a threshold.

In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

FIG. 1 is a schematic illustration of an exemplary electronic device 100 which may be adapted to implement battery power management as described herein, in accordance with some embodiments. In one embodiment, electronic device 100 includes one or more accompanying input/output devices including a display 102 having a screen 104, one or more speakers 106, a keyboard 110, one or more temperature sensors 112, and a mouse 114. In various embodiments, the electronic device 100 may be embodied as a personal computer, a laptop computer, a personal digital assistant, a mobile telephone, an entertainment device, or another computing device.

The electronic device 100 includes system hardware 120 and memory 130, which may be implemented as random access memory and/or read-only memory. A power source such as a battery 180 may be coupled to the electronic device 100.

System hardware 120 may include one or more processors 122, one or more graphics processors 124, network interfaces 126, and bus structures 128. In one embodiment, processor 122 may be embodied as an Intel® Core2 Duo® processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

In some embodiments one of the processors 122 in system hardware 120 may comprise a low-power embedded processor, referred to herein as a manageability engine (ME). The manageability engine may be implemented as an independent integrated circuit or may be a dedicated portion of a larger processor 122.

Graphics processor(s) 124 may function as adjunct processor that manages graphics and/or video operations. Graphics processor(s) 124 may be integrated onto the motherboard of electronic device 100 or may be coupled via an expansion slot on the motherboard.

In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

Memory 130 may include an operating system 140 for managing operations of electronic device 100. In one embodiment, operating system 140 includes a hardware interface module 154 that provides an interface to system hardware 120. In addition, operating system 140 may include a file system 150 that manages files used in the operation of electronic device 100 and a process control subsystem 152 that manages processes executing on electronic device 100.

Operating system 140 may include (or manage) one or more communication interfaces that may operate in conjunction with system hardware 120 to transceive data packets and/or data streams from a remote source. Operating system 140 may further include a system call interface module 142 that provides an interface between the operating system 140 and one or more application modules resident in memory 130. Operating system 140 may be embodied as a UNIX operating system or any derivative thereof (e.g., Linux, Solaris, etc.) or as a Windows® brand operating system, or other operating systems.

In some embodiments memory 130 may further comprise one or more applications which may execute on the one or more processors 122 including a power driver 162. These applications may be embodied as logic instructions stored in a tangible, non-transitory computer readable medium (i.e., software or firmware) which may be executable on one or more of the processors 122. Alternatively, these applications may be embodied as logic on a programmable device such as a field programmable gate array (FPGA) or the like. Alternatively, these applications may be reduced to logic that may be hardwired into an integrated circuit.

In some embodiments electronic device 100 may comprise a low-power embedded processor, referred to herein as an adjunct controller 170. The adjunct controller 170 may be implemented as an independent integrated circuit located on the motherboard of the system 100. In some embodiments the adjunct controller 170 may comprise one or more processors 172 and a memory module 174, and the power driver 162 may be implemented in the controller 170. By way of example, the memory module 174 may comprise a persistent flash memory module and the power driver 162 may be implemented as logic instructions encoded in the persistent memory module, e.g., firmware or software. Because the adjunct controller 170 is physically separate from the main processor(s) 122 and operating system 140, the adjunct controller 170 may be made secure, i.e., inaccessible to hackers such that it cannot be tampered with.

Operations implemented by power driver 162 are described in greater detail below, with reference to FIG. 3. Power driver 162 receives input from location service(s) 160 and/or user profiler 164 and uses the inputs to select one of a plurality of charge routines for a battery which may be coupled to electronic device 100.

FIG. 2 is a schematic illustration of another embodiment of an electronic device 210 which may be adapted to which may be adapted to implement battery power management as described herein, according to embodiments. In some embodiments electronic device 210 may be embodied as a mobile telephone, a personal digital assistant (PDA), a laptop computer, or the like. Electronic device 210 may include one or more temperature sensors 212, an RF transceiver 220 to transceive RF signals and a signal processing module 222 to process signals received by RF transceiver 220.

RF transceiver 220 may implement a local wireless connection via a protocol such as, e.g., Bluetooth or 802.11X. IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Electronic device 210 may further include one or more processors 224 and a memory module 240. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit. In some embodiments, processor 224 may be one or more processors in the family of Intel® PXA27x processors available from Intel® Corporation of Santa Clara, Calif. Alternatively, other CPUs may be used, such as Intel's Itanium®, XEON™, ATOM™, and Celeron® processors. Also, one or more processors from other manufactures may be utilized. Moreover, the processors may have a single or multi core design.

In some embodiments, memory module 240 includes random access memory (RAM); however, memory module 240 may be implemented using other memory types such as dynamic RAM (DRAM), synchronous DRAM (SDRAM), and the like. Memory 240 may comprise one or more applications which execute on the processor(s) 222.

Electronic device 210 may further include one or more input/output interfaces such as, e.g., a keypad 226 and one or more displays 228. In some embodiments electronic device 210 comprises one or more camera modules 220 and an image signal processor 232, and speakers 234. A power source such as a battery 270 may be coupled to electronic device 210.

In some embodiments electronic device 210 may include an adjunct controller 270 which may be implemented in a manner analogous to that of adjunct controller 170, described above. In the embodiment depicted in FIG. 2 the adjunct controller 270 comprises one or more processor(s) 272 and a memory module 274, which may be implemented a persistent flash memory module. Because the adjunct controller 270 is physically separate from the main processor(s) 224, the adjunct controller 270 may be made secure, i.e., inaccessible to hackers such that it cannot be tampered with.

In some embodiments at least one of the memory 230 or the controller 270 may comprise a power driver 164, which may be implemented as logic instructions encoded in the persistent memory module, e.g., firmware or software.

Operations of the power driver 162 will be described with reference to FIGS. 3-5. Referring first to FIG. 3, at operation 310 the power driver receives a temperature indicator. By way of example, in some embodiments the power driver 162 may be configured to wake up on a periodic basis and to launch a query to the temperature sensor(s) 112/212 in order to receive periodic temperature indicators. The temperature sensor(s) 112/212 may be located proximate the battery of the electronic device, inside a housing of the electronic device, or on a exterior surface of the electronic device. At operation 315 the power driver 162 determines a temperature parameter from the received temperature indicator. By way of example, in some embodiments the power driver 162 may maintain a rolling average temperature parameter over a number, n, previous samples of the temperature indicator(s) in order to smooth out variations in the sampled temperature indicator data. In alternate embodiments the power driver 162 may treat the temperature indicator as the temperature parameter. One skilled in the art will recognize that various other statistical manipulations of the temperature indicators may be performed to derive the temperature parameter.

If, at operation 320, the temperature parameter determined at operation 320 is not less than a predetermined threshold then control passes back to operation 310 By contrast, if at operation 320 temperature parameter is lower than the predetermined threshold then control passes to operation 325 and the power driver 162 implements a power management routine. The threshold set in operation 320 may be a function of the chemistry used to implement the battery which powers the electronic device. By way of example, in some embodiments the temperature threshold may be set to zero degrees Celsius. In alternate embodiments the threshold may be set by a user through a suitable user interface.

Thus, operations 310-325 implement a loop pursuant to which the power driver 162 may monitor a temperature of the electronic device and implement a power management routine when the temperature falls below or above ? a predetermined threshold.

In some embodiments the power management routine implemented at operation 325 may comprise one or more operations to increase the temperature of the battery to be coupled to the electronic device. By way of example in some embodiments the power management routine may comprise activating one or more applications that execute on the electronic device such that one or more heat generating components of the electronic device are powered on to generate heat, thereby heating the battery. In alternate embodiments the power management routine may cycle a display of the electronic device between an on state and an off state in order to generate heat, thereby heating the battery.

Referring to FIG. 4, in some embodiments the electronic device may be provided with a first battery 410 and a second battery 420. First battery 410 may be the primary battery which powers the electronic device and may use a Lithium-ion battery chemistry. Second battery 420 may be an auxiliary battery which has a chemistry designed to work at a temperature lower than the threshold. By way of example, in some embodiments the secondary battery may utilize lithium trifluorochloroborate (LiBF₃Cl) battery chemistry. Batteries 410, 420 may be coupled to a controller which executes the power driver 162. In operation, a system having the configuration depicted in FIG. 4 may implement a power management routine which activates the electronic device using the second battery when the temperature is less than the threshold.

Referring to FIG. 5, in some embodiments the electronic device may be provided with a heater 440 proximate the first battery 410. In operation, a system having the configuration depicted in FIG. 4 may implement a power management routine which activates the electronic device using the second battery when the temperature is less than the threshold.

As described above, in some embodiments the electronic device may be embodied as a computer system. FIG. 6 illustrates a block diagram of a computing system 600 in accordance with an embodiment of the invention. The computing system 600 may include one or more central processing unit(s) (CPUs) 602 or processors that communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors. In an embodiment, one or more of the processors 602 may be the same or similar to the processors 102 of FIG. 1. For example, one or more of the processors 602 may include the control unit 120 discussed with reference to FIGS. 1-3. Also, the operations discussed with reference to FIGS. 3-5 may be performed by one or more components of the system 600.

A chipset 606 may also communicate with the interconnection network 604. The chipset 606 may include a memory control hub (MCH) 608. The MCH 608 may include a memory controller 610 that communicates with a memory 612 (which may be the same or similar to the memory 130 of FIG. 1). The memory 412 may store data, including sequences of instructions, that may be executed by the CPU 602, or any other device included in the computing system 600. In one embodiment of the invention, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple CPUs and/or multiple system memories.

The MCH 608 may also include a graphics interface 614 that communicates with a display device 616. In one embodiment of the invention, the graphics interface 614 may communicate with the display device 616 via an accelerated graphics port (AGP). In an embodiment of the invention, the display 616 (such as a flat panel display) may communicate with the graphics interface 614 through, for example, a signal converter that translates a digital representation of an image stored in a storage device such as video memory or system memory into display signals that are interpreted and displayed by the display 616. The display signals produced by the display device may pass through various control devices before being interpreted by and subsequently displayed on the display 616.

A hub interface 618 may allow the MCH 608 and an input/output control hub (ICH) 620 to communicate. The ICH 620 may provide an interface to I/O device(s) that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the CPU 602 and peripheral devices. Other types of topologies may be utilized. Also, multiple buses may communicate with the ICH 620, e.g., through multiple bridges or controllers. Moreover, other peripherals in communication with the ICH 620 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and a network interface device 630 (which is in communication with the computer network 603). Other devices may communicate via the bus 622. Also, various components (such as the network interface device 630) may communicate with the MCH 608 in some embodiments of the invention. In addition, the processor 602 and one or more other components discussed herein may be combined to form a single chip (e.g., to provide a System on Chip (SOC)). Furthermore, the graphics accelerator 616 may be included within the MCH 608 in other embodiments of the invention.

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

FIG. 7 illustrates a block diagram of a computing system 700, according to an embodiment of the invention. The system 700 may include one or more processors 702-1 through 702-N (generally referred to herein as “processors 702” or “processor 702”). The processors 702 may communicate via an interconnection network or bus 704. Each processor may include various components some of which are only discussed with reference to processor 702-1 for clarity. Accordingly, each of the remaining processors 702-2 through 702-N may include the same or similar components discussed with reference to the processor 702-1.

In an embodiment, the processor 702-1 may include one or more processor cores 706-1 through 706-M (referred to herein as “cores 706” or more generally as “core 706”), a shared cache 708, a router 710, and/or a processor control logic or unit 720. The processor cores 706 may be implemented on a single integrated circuit (IC) chip. Moreover, the chip may include one or more shared and/or private caches (such as cache 708), buses or interconnections (such as a bus or interconnection network 712), memory controllers, or other components.

In one embodiment, the router 710 may be used to communicate between various components of the processor 702-1 and/or system 700. Moreover, the processor 702-1 may include more than one router 710. Furthermore, the multitude of routers 710 may be in communication to enable data routing between various components inside or outside of the processor 702-1.

The shared cache 708 may store data (e.g., including instructions) that are utilized by one or more components of the processor 702-1, such as the cores 706. For example, the shared cache 708 may locally cache data stored in a memory 714 for faster access by components of the processor 702. In an embodiment, the cache 708 may include a mid-level cache (such as a level 2 (L2), a level 3 (L3), a level 4 (L4), or other levels of cache), a last level cache (LLC), and/or combinations thereof. Moreover, various components of the processor 702-1 may communicate with the shared cache 708 directly, through a bus (e.g., the bus 712), and/or a memory controller or hub. As shown in FIG. 7, in some embodiments, one or more of the cores 706 may include a level 1 (L1) cache 716-1 (generally referred to herein as “L1 cache 716”). In one embodiment, the controller 720 may include logic to implement the operations described above with reference to FIG. 3.

FIG. 8 illustrates a block diagram of portions of a processor core 706 and other components of a computing system, according to an embodiment of the invention. In one embodiment, the arrows shown in FIG. 8 illustrate the flow direction of instructions through the core 706. One or more processor cores (such as the processor core 706) may be implemented on a single integrated circuit chip (or die) such as discussed with reference to FIG. 7. Moreover, the chip may include one or more shared and/or private caches (e.g., cache 708 of FIG. 7), interconnections (e.g., interconnection 704 of FIG. 7), control units, memory controllers, or other components.

As illustrated in FIG. 8, the processor core 706 may include a fetch unit 802 to fetch instructions (including instructions with conditional branches) for execution by the core 706. The instructions may be fetched from any storage devices such as the memory 714. The core 706 may also include a decode unit 804 to decode the fetched instruction. For instance, the decode unit 804 may decode the fetched instruction into a plurality of uops (micro-operations).

Additionally, the core 706 may include a schedule unit 806. The schedule unit 806 may perform various operations associated with storing decoded instructions (e.g., received from the decode unit 804) until the instructions are ready for dispatch, e.g., until all source values of a decoded instruction become available. In one embodiment, the schedule unit 806 may schedule and/or issue (or dispatch) decoded instructions to an execution unit 808 for execution. The execution unit 808 may execute the dispatched instructions after they are decoded (e.g., by the decode unit 804) and dispatched (e.g., by the schedule unit 806). In an embodiment, the execution unit 808 may include more than one execution unit. The execution unit 808 may also perform various arithmetic operations such as addition, subtraction, multiplication, and/or division, and may include one or more an arithmetic logic units (ALUs). In an embodiment, a co-processor (not shown) may perform various arithmetic operations in conjunction with the execution unit 808.

Further, the execution unit 808 may execute instructions out-of-order. Hence, the processor core 706 may be an out-of-order processor core in one embodiment. The core 706 may also include a retirement unit 810. The retirement unit 810 may retire executed instructions after they are committed. In an embodiment, retirement of the executed instructions may result in processor state being committed from the execution of the instructions, physical registers used by the instructions being de-allocated, etc.

The core 706 may also include a bus unit 714 to enable communication between components of the processor core 706 and other components (such as the components discussed with reference to FIG. 8) via one or more buses (e.g., buses 804 and/or 812). The core 706 may also include one or more registers 816 to store data accessed by various components of the core 706 (such as values related to power consumption state settings).

Furthermore, even though FIG. 7 illustrates the control unit 720 to be coupled to the core 706 via interconnect 812, in various embodiments the control unit 720 may be located elsewhere such as inside the core 706, coupled to the core via bus 704, etc.

In some embodiments, one or more of the components discussed herein can be embodied as a System On Chip (SOC) device. FIG. 9 illustrates a block diagram of an SOC package in accordance with an embodiment. As illustrated in FIG. 9, SOC 902 includes one or more Central Processing Unit (CPU) cores 920, one or more Graphics Processor Unit (GPU) cores 930, an Input/Output (I/O) interface 940, and a memory controller 942. Various components of the SOC package 902 may be coupled to an interconnect or bus such as discussed herein with reference to the other figures. Also, the SOC package 902 may include more or less components, such as those discussed herein with reference to the other figures. Further, each component of the SOC package 902 may include one or more other components, e.g., as discussed with reference to the other figures herein. In one embodiment, SOC package 902 (and its components) is provided on one or more Integrated Circuit (IC) die, e.g., which are packaged into a single semiconductor device.

As illustrated in FIG. 9, SOC package 902 is coupled to a memory 960 (which may be similar to or the same as memory discussed herein with reference to the other figures) via the memory controller 942. In an embodiment, the memory 960 (or a portion of it) can be integrated on the SOC package 902.

The I/O interface 940 may be coupled to one or more I/O devices 970, e.g., via an interconnect and/or bus such as discussed herein with reference to other figures. I/O device(s) 970 may include one or more of a keyboard, a mouse, a touchpad, a display, an image/video capture device (such as a camera or camcorder/video recorder), a touch screen, a speaker, or the like.

The following examples pertain to further embodiments.

Example 1 is computer program product comprising logic instructions stored in a non-transitory computer readable medium which, when executed by a controller, configure the controller to perform operations, comprising receiving, in the controller, a temperature indicator for an electronic device to be coupled to a first battery and implementing, in the controller, a power management routine when one or more temperature indicators has a predetermined relationship with a threshold.

The logic instructions may configure the controller to perform operations comprising activating the controller on a periodic basis and querying a temperature sensor on a periodic basis.

In some embodiments the one or more temperature indicators comprises an average of temperature indicators over a predetermined time period. In some embodiments the power management routine comprises activating at least one heat generating component on the electronic device. In some embodiments In some embodiments the power management routine comprises cycling a display on the electronic device between an on state and an off state. In some embodiments the power management routine comprises activating a second battery for the electronic device. In some embodiments the power management routine comprises activating a heater in thermal communication with the first battery.

In example 2, a controller comprising logic, at least a portion of which is in hardware, to receive a temperature indicator for an electronic device to be coupled to a first battery and implement a power management routine when one or more temperature indicators has a predetermined relationship with a threshold.

In some embodiments the logic is to activate the controller on a periodic basis and query a temperature sensor on a periodic basis.

In some embodiments the one or more temperature indicators comprises an average of temperature indicators over a predetermined time period. In some embodiments the power management routine comprises activating at least one heat generating component on the electronic device. In some embodiments In some embodiments the power management routine comprises cycling a display on the electronic device between an on state and an off state. In some embodiments the power management routine comprises activating a second battery for the electronic device. In some embodiments the power management routine comprises activating a heater in thermal communication with the first battery.

In example 4, an apparatus comprises means for receiving a temperature indicator for an electronic device to be coupled to a first battery and means for implementing a power management routine when one or more temperature indicators has a predetermined relationship with a threshold.

In some embodiments the one or more temperature indicators comprises an average of temperature indicators over a predetermined time period. In some embodiments the power management routine comprises activating at least one heat generating component on the electronic device. In some embodiments In some embodiments the power management routine comprises cycling a display on the electronic device between an on state and an off state. In some embodiments the power management routine comprises activating a second battery for the electronic device. In some embodiments the power management routine comprises activating a heater in thermal communication with the first battery.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “some embodiments” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A computer program product comprising logic instructions stored in a non-transitory computer readable medium which, when executed by a controller, configure the controller to perform operations, comprising:
receiving, in the controller, a temperature indicator for an electronic device to be coupled to a first battery; and
implementing, in the controller, a power management routine when one or more temperature indicators has a predetermined relationship with a threshold.

2. The computer program product of claim 1, comprising logic instructions stored in the non-transitory computer readable medium which, when executed by the controller, configure the controller to perform operations comprising:
activating the controller on a periodic basis; and
querying a temperature sensor on a periodic basis.

3. The computer program product of claim 1, wherein the one or more temperature indicators comprises an average of temperature indicators over a predetermined time period.

4. The computer program product of claim 1, wherein the power management routine comprises activating at least one heat generating component on the electronic device.

5. The computer program product of claim 1, wherein the power management routine comprises cycling a display on the electronic device between an on state and an off state.

6. The computer program product of claim 1, wherein the power management routine comprises activating a second battery for the electronic device.

7. The computer program product of claim 6, wherein the power management routine comprises activating a heater in thermal communication with the first battery.

8. A controller comprising logic, at least a portion of which is in hardware, to:
receive a temperature indicator for an electronic device to be coupled to a first battery; and
implement a power management routine when one or more temperature indicators has a predetermined relationship with a threshold.

9. The controller of claim 8, wherein the logic is to:
activate the controller on a periodic basis; and
query a temperature sensor on a periodic basis.

10. The controller of claim 8, wherein the one or more temperature indicators comprises an average of temperature indicators over a predetermined time period.

11. The controller of claim 8, wherein the power management routine is to activate at least one heat generating component on the electronic device.

12. The controller of claim 8, wherein the power management routine comprises cycling a display on the electronic device between an on state and an off state.

13. The controller of claim 8, wherein the power management routine comprises activating a second battery for the electronic device.

14. The controller of claim 13, wherein the power management routine comprises activating a heater in thermal communication with the first battery.

15. An electronic device, comprising:
a first battery;
a controller comprising logic to:
receive a temperature indicator for an electronic device to be coupled to a first battery; and
implement a power management routine when one or more temperature indicators has a predetermined relationship with a threshold.

16. The electronic device of claim 15, comprising logic to:
activate the controller on a periodic basis; and
query a temperature sensor on a periodic basis.

17. The electronic device of claim 15, wherein the temperature parameter comprises an average of temperature indicators collected over a predetermined time period.

18. The electronic device of claim 15, wherein the power management routine comprises activating at least one heat generating component on the electronic device.

19. The electronic device of claim 15, wherein the power management routine comprises cycling a display on the electronic device between an on state and an off state.

20. The electronic device of claim 15, wherein the power management routine comprises activating a second battery for the electronic device.

21. The electronic device of claim 20, wherein the power management routine comprises activating a heater in thermal communication with the first battery.

22. A method, comprising:
receiving, in a controller, a temperature indicator for an electronic device to be coupled to a first battery; and
implementing, in the controller, a selected power management routine when one or more temperature indicators has a predetermined relationship with a threshold.

23. The method of claim 22, wherein receiving, in a controller, a temperature indicator for an electronic device to be coupled to the battery comprises:
activating the controller on a periodic basis; and
querying a temperature sensor on a periodic basis.

24. The method of claim 22, wherein the one or more temperature indicators comprises an average of temperature indicators collected over a predetermined time period.

25. The method of claim 22, wherein the power management routine comprises activating at least one heat generating component on the electronic device.
